(19) United States
(12) Patent Application Publication
(10) Pub. No.: US 2025/0200346 A1
(43) Pub. Date: Jun. 19, 2025

(54) DATA PROCESSING DEVICE OF SPIKING NEURAL NETWORK AND OPERATING METHOD THEREOF

(71) Applicant: Electronics and Telecommunications Research Institute, Daejeon (KR)

(72) Inventors: Tae Wook KANG, Daejeon (KR); Sung Eun KIM, Daejeon (KR); Hyuk KIM, Daejeon (KR); Kyung Jin BYUN, Daejeon (KR); Kwang IL OH, Daejeon (KR); Jae-Jin LEE, Daejeon (KR)

(73) Assignee: Electronics and Telecommunications Research Institute, Daejeon (KR)

(21) Appl. No.: 18/805,737

(22) Filed: Aug. 15, 2024

(30) Foreign Application Priority Data
Dec. 15, 2023 (KR) 10-2023-0183573

(51) Int. Cl. G06N 3/049

(52) U.S. Cl. CPC G06N 3/049

(57) ABSTRACT

Disclosed is a data processing device of the spiking neural network, which includes a discretizer that receives time-series data, discretizes the time-series data based on sampling, and outputs sampled time-series data, and a control unit that receives the sampled time-series data, extracts a voltage feature and a time feature from the sampled time-series data, and increases the number of spikes firing in an input neuron each corresponding to the voltage feature and the time feature extracted from a plurality of input neurons including first to n-th input neurons, with respect to the “n”, which is an arbitrary positive integer.

### CROSS-REFERENCE TO RELATED APPLICATIONS

This application claims priority under 35 U.S.C. § 119 to Korean Patent Application No. 10-2023-0183573 filed on Dec. 15, 2023, in the Korean Intellectual Property Office, the disclosures of which are incorporated by reference herein in their entireties.

### BACKGROUND

Embodiments of the present disclosure described herein relate to a data processing device and an operating method thereof for a spiking neural network, and more particularly, relate to a data processing device capable of extracting features of time-series input data and converting the extracted features into spike signals, and an operating method thereof.

A spiking neural network (SNN) is one of artificial neural networks (ANNs) that implement a network by creating a circuit by imitating shapes of human neurons. Unlike perceptron-based neural networks or convolution-based neural networks, in the SNN, rather than a signal at a specific level, a spike signal having a pulse shape that toggles for a short period of time may be transferred between neurons. Therefore, the SNN may quickly process data and operate with low power.

### SUMMARY

Embodiments of the present disclosure provide a data processing device that extracts features of time-series data and converting the extracted features into spike signals, and the operating method thereof.

According to an embodiment of the present disclosure, a data processing device of the spiking neural network, which includes a discretizer that receives time-series data, discretizes the time-series data based on sampling, and outputs sampled time-series data, and a control unit that receives the sampled time-series data, extracts a voltage feature and a time feature from the sampled time-series data, and increases the number of spikes firing in an input neuron corresponding to the voltage feature and the time feature from among a plurality of input neurons including first to n-th input neurons, with respect to the “n”, which is an arbitrary positive integer.

According to an embodiment, the control unit may include a voltage comparator that detects that a voltage of the sampled time-series data passes sequentially or in reverse order between a k-th threshold voltage and a (k+1)-th threshold voltage adjacent to each other, with respect to the “k” that is an arbitrary positive integer less than the “m”, from among a plurality of threshold voltages including first to m-th threshold voltages, magnitudes of which increase sequentially, with respect to the “m” that is an arbitrary positive integer less than the “n”, and a first spike number allocator that increases the number of spikes firing in an input neuron corresponding to the (k+1)-th threshold voltage among the plurality of input neurons when the voltage of the sampled time-series data sequentially passes between the k-th threshold voltage and the (k+1)-th threshold voltage, and increases the number of spikes firing in an input neuron corresponding to the k-th threshold voltage among the plurality of input neurons when the voltage of the sampled time-series data passes in reverse order between the k-th threshold voltage and the (k+1)-th threshold voltage.

According to an embodiment, the data processing device of the spiking neural network may further include a counter that measures a time value taken when the voltage of the sampled time-series data passes sequentially or in reverse order between the k-th threshold voltage and the (k+1)-th threshold voltage, as an arbitrary integer, a normalization device that normalizes the time value within a specific range to calculate the normalized time value, and a second spike number allocator that increases the number of spikes firing in an input neuron corresponding to the normalized time value.

According to an embodiment, the normalization device may receive the time value from the counter, may multiply the received time value by a normalization factor to normalize the time value within the specific range, and may calculate the normalized time value, and the specific range is a range of m+1 or more and “n” or less.

According to an embodiment, the number of spikes firing in the input neuron, which is increased by the first and second spike number allocators may be “1” or an arbitrary integer.

According to an embodiment, the first to m-th threshold voltages may correspond to first to m-th input neurons among the first to n-th input neurons, respectively, and the normalized time value having a value within the range of the m+1 or more and the “n” or less may correspond to the (m+1)-th to n-th input neurons among the first to n-th input neurons, each of which has an index matching the normalized time value.

According to an embodiment, the number of spikes fired by the input neuron may be proportional to the number of spikes increased by the first and second spike number allocators, and a distribution of the spikes has a Poisson distribution.

According to an embodiment of the present disclosure, a method of operating a data processing device of a spiking neural network includes receiving time-series data, by a discretizer, and discretizing the time-series data based on sampling to output sampled time-series data, and receiving, by a control unit, the sampled time-series data, extracting a voltage feature and a time feature from the sampled time-series data, and increasing the number of spikes firing in an input neuron corresponding to the voltage feature and the time feature from among a plurality of input neurons including first to n-th input neurons, with respect to the “n” that is an arbitrary positive integer.

According to an embodiment, the increasing of the number of spikes may include detecting, by a voltage comparator, that a voltage of the sampled time-series data passes sequentially or in reverse order between a k-th threshold voltage and a (k+1)-th threshold voltage adjacent to each other, with respect to the “k” that is an arbitrary positive integer less than the “m”, from among a plurality of threshold voltages including first to m-th threshold voltages, magnitudes of which increase sequentially, with respect to the “m” that is an arbitrary positive integer less than the “n”, increasing, by a first spike number allocator, the number of spikes firing in an input neuron corresponding to the (k+1)-th threshold voltage among the plurality of input neurons when the voltage of the sampled time-series data sequentially passes between the k-th threshold voltage and the (k+1)-th threshold voltage, and increasing the number of spikes firing in an input neuron corresponding to the k-th threshold voltage among the plurality of input neurons when the voltage of the sampled time-series data passes in reverse order between the k-th threshold voltage and the (k+1)-th threshold voltage.

According to an embodiment, the increasing of the number of spikes may include measuring, by a counter, a time value taken when the voltage of the sampled time-series data passes sequentially or in reverse order between the k-th threshold voltage and the (k+1)-th threshold voltage, as an arbitrary integer, normalizing, by a normalization device, the time value within a specific range to calculate the normalized time value, and increasing, by a second spike number allocator, the number of spikes firing in an input neuron corresponding to the normalized time value.

According to an embodiment, the calculating of the normalized time value may further include receiving, by the normalization device, the time value, and multiplying the received time value by a normalization factor to normalize the time value within the specific range.

According to an embodiment, the number of spikes firing in the input neuron increased by the first and second spike number allocators may be “1” or an arbitrary integer.

According to an embodiment, the first to m-th threshold voltages may correspond to first to m-th input neurons among the first to n-th input neurons, respectively, and the normalized time value having a value within the range of the m+1 or more and the “n” or less may correspond to the (m+1)-th to n-th input neurons among the first to n-th input neurons, each of which has an index matching the normalized time value.

According to an embodiment, the method may further includes firing, by the input neuron, spikes, the number of which is proportional to the number of spikes increased by the first and second spike number allocators, and the firing spikes may have a Poisson distribution.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a spiking neural network, according to an embodiment of the present disclosure.

FIG. 2 is a block diagram illustrating a data processing unit, according to an embodiment of the present disclosure.

FIG. 3 is a block diagram illustrating a control unit, according to an embodiment of the present disclosure.

FIG. 4 is a diagram illustrating an input neuron layer, according to an embodiment of the present disclosure.

FIG. 5 is a flowchart illustrating a method of operating a data processing unit, according to an embodiment of the present disclosure.

FIG. 6 is a flowchart illustrating a method of operating a control unit, according to an embodiment of the present disclosure.

FIG. 7 is a graph illustrating an extraction of voltage features and time features of time-series data, according to an embodiment of the present disclosure.

FIG. 8 is a block diagram illustrating an electronic device, according to an embodiment of the present disclosure.

### DETAILED DESCRIPTION

Hereinafter, embodiments of the present disclosure will be described in detail and clearly to such an extent that an ordinary one in the art easily implements the present disclosure.

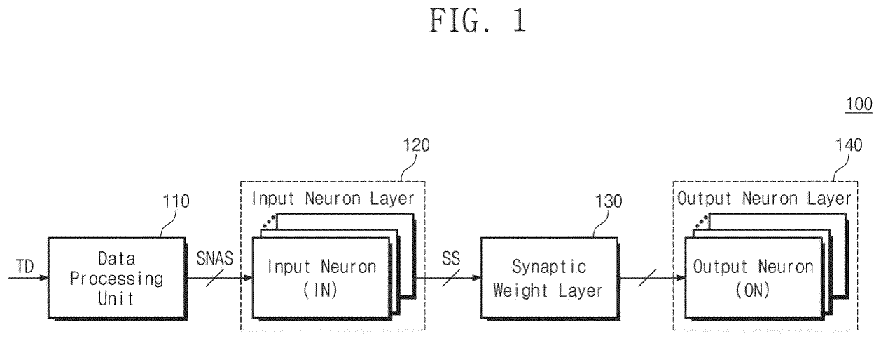

FIG. 1 is a block diagram illustrating a spiking neural network (SNN) 100, according to an embodiment of the present disclosure. Referring to FIG. 1, the spiking neural network 100 may include a data processing unit 110, an input neuron layer 120, a synaptic weight layer 130, and an output neuron layer 140.

The data processing unit 110 may receive time-series data TD (e.g., analog data) that changes continuously over time from the outside (not illustrated) of the spiking neural network (SNN).

The input neuron layer 120 may include at least one input neuron IN, and the output neuron layer 140 may include at least one output neuron ON. The input neuron may transfer the spike signal to the synaptic weight layer 130. The synaptic weight layer 130 may multiply the spike signal by a weight based on a value of a synaptic weight, and may transfer the spike signal in which the weight is multiplied to each output neuron.

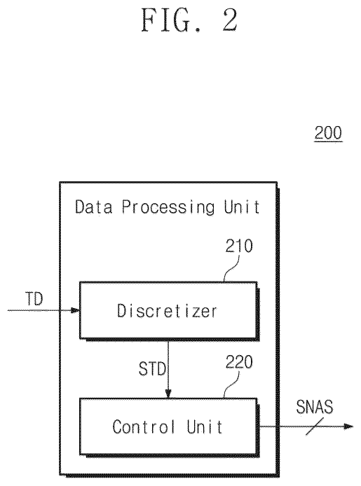

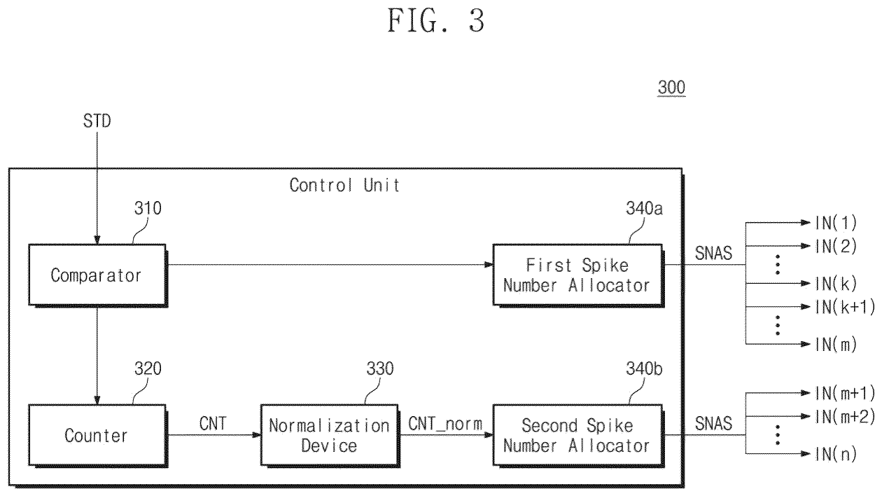

In detail, the data processing unit 110 extracts voltage features and time features of the received time-series data TD, and may output a spike number allocating signal SNAS to each input neuron IN corresponding to the input neuron layer 120 based on the extracted features. The input neuron layer 120 may transfer the spike signal reflecting voltage features and time features to the synaptic weight layer 130. The synaptic weight layer 130 may perform STDP (Spike-Timing-Dependent Plasticity)-style unsupervised learning based on the spike signal in which voltage features and time features are reflected. Each output neuron ON of the output neuron layer 140 may receive spike signals multiplied by the weight of the learned synaptic weight layer 130. Each output neuron ON of the output neuron layer 140 may accumulate received spike signals. The synaptic weight layer 130 performs learning by reflecting the time features of the time-series data TD, so the spiking neural network 100 may perform spike encoding suitable for online evolving capable of adaptive learning on the changing features of the time-series data TD. The process of extracting features from the time-series data TD will be described in detail in FIGS. 2 and 3.

FIG. 2 is a block diagram illustrating a data processing unit 200, according to an embodiment of the present disclosure. Referring to FIG. 2, the data processing unit 200 may include a discretizer 210 and a control unit 220.

The discretizer 210 may be configured with, for example, a sampler.

The time-series data TD received to the data processing unit 200 from the outside (not illustrated) may be input to the discretizer 210. The discretizer 210 may generate sampled time-series data STD by discretizing the received time-series data TD based on sampling. The discretizer 210 may output the sampled time-series data to the control unit 220.

The control unit 220 may extract voltage features and time features from the received sampled time-series data STD, and may output the spike number allocating signal to each input neuron IN of the input neuron layer 120 corresponding to each extracted features.

The processes of extracting features in the control unit 220 and

outputting the spike number allocating signal SNAS to each corresponding input neuron IN will be described in detail in FIG. 3 below.

FIG. 3 is a block diagram illustrating a control unit 300, according to an embodiment of the present disclosure. Referring to FIG. 3, the control unit 300 may include a comparator 310, a counter 320, a normalization device 330, a first spike number allocator 340a, and a second spike number allocator 340b.

In this specification, input neurons IN included in the input neuron layer may include first to n-th input neurons IN(1) to IN(n) (where, “n” is an arbitrary positive integer).

The sampled time-series data STD received in the control unit 300 may be provided to the comparator 310. The comparator 310 may include at least one voltage comparator. The comparator 310 may detect that the voltage of the sampled time-series data STD passes a plurality of threshold voltages, for example, first to m-th threshold voltages Vth(1) to Vth(m) (where, “m” is an arbitrary positive integer less than “n”). In this specification, it is assumed that the first to m-th threshold voltages Vth(1) to Vth(m), magnitudes of which increase sequentially (i.e., Vth(1)<Vth(2)< . . . <Vth(m)). In this case, the first to m-th threshold voltages Vth(1) to Vth(m) may sequentially correspond to the first to m-th input neurons IN(1) to IN(m), respectively.

In detail, the comparator 310 may detect that the voltage of the sampled time-series data STD passes sequentially or in reverse order arbitrary two nearest threshold voltages among the first to m-th threshold voltages Vth(1) to Vth(m), for example, a k-th threshold voltage Vth(k) and a (k+1)-th threshold voltage Vth(k+1) (where, “k” is an arbitrary positive integer less than “m”).

When the comparator 310 detects that the voltage of the sampled time-series data STD passes sequentially two adjacent threshold voltages, for example, the k-th threshold voltage Vth(k) and the (k+1)-th threshold voltage Vth(k+1), that is, when the voltage of the sampled time-series data STD passes the k-th threshold voltage Vth(k) and then passes the (k+1)-th threshold voltage Vth(k+1), the first spike number allocator 340a may output the spike number allocating signal SNAS that increases the number of spikes firing in the (k+1)-th input neuron IN(k+1) corresponding to the (k+1)-th threshold voltage Vth(k+1).

In addition, when the comparator 310 detects that the voltage of the sampled time-series data STD passes in reverse order two adjacent threshold voltages, for example, the k-th threshold voltage Vth(k) and the (k+1)-th threshold voltage Vth(k+1), that is, when the voltage of the sampled time-series data STD passes the (k+1)-th threshold voltage Vth(k+1) and then passes the k-th threshold voltage Vth(k), the first spike number allocator 340a may output the spike number allocating signal SNAS that increases the number of spikes firing in the k-th input neuron IN(k) corresponding to the k-th threshold voltage Vth(k).

When the comparator 310 detects that the voltage of the sampled time-series data STD passes sequentially or reverse order the two adjacent threshold voltages, that is, the k-th threshold voltage Vth(k) and the (k+1)-th threshold voltage Vth(k+1), the counter 320 may measure the time value CNT taken when the voltage of the sampled time-series data STD passes the two adjacent threshold voltages, that is, the k-th threshold voltage Vth(k) and the (k+1)-th threshold voltage Vth(k+1). For example, the time value CNT may be measured as an integer. The counter may output the measured time value CNT to the normalization device 330.

The normalization device 330 may normalize the time value CNT received from the counter to a range of m+1 or more to n or less. In detail, the normalization device 330 may perform normalization such that normalized time value CNT_norm calculated by multiplying the time value CNT by a normalization factor “ρ” has an integer value of m+1 or more and “n” or less (i.e., m+1≤CNT·ρ=CNT_norm≤n).

The second spike number allocator 340b may output the spike number allocating signal SNAS that increases the number of spikes firing in the input neuron IN corresponding to the normalized time value CNT_norm calculated by normalizing the time value CNT through the normalization device 330. In this case, the input neuron corresponding to the normalized time value CNT_norm to have the integer value of m+1 or more and “n” or less may be j-th input neuron IN(j) (where. “j” is CNT_norm).

The spike number allocating signal SNAS output from the first spike number allocator 340a and the second spike number allocator 340b may increase the number of spikes firing in each corresponding input neuron by “1” or an arbitrary integer.

By the operation of the data processing unit 200 described above, the first to m-th input neurons IN(1) to IN(m) may receive and encode the voltage features of the time-series data TD, and the (m+1)-th to n-th input neurons IN(m+1) to IN(n) may receive and encode the time features of the time-series data TD. The number (or increase in number) of spikes firing in each of the first to n-th input neurons IN(1) to IN(n) may be proportional to the degree of inclusion (e.g., importance and/or magnitude) of information about the features (e.g., the threshold voltage or the normalized time value) corresponding to each of the first to n-th input neurons IN(1) to IN(n) of the time-series data TD.

For example, an increase in the number of spikes firing in the k-th input neuron IN(k) means that the voltage of the time-series data TD includes many signal change components related to the k-th threshold voltage Vth(k) corresponding to the k-th input neuron IN(k). In detail, the increase in the number of spikes may mean that the voltage of the time-series data TD passes the k-th threshold voltage Vth(k) many times (e.g., both when the waveform is rising and when the waveform is falling).

In addition, for example, an increase in the number of spikes firing in the j-th input neuron IN(j) (where, “j” is CNT_norm) may mean that the time-series data TD includes many signal change components related to the time value CNT before the normalized time value CNT_norm corresponding to the j-th input neuron IN(j) is normalized. In detail, the increase in the number of spikes means that the time-series data TD passes through the two nearest threshold voltages, for example, the k-th threshold voltage Vth(k) and the (k+1)-th threshold voltage Vth(k+1) at an interval of time value CNT many times (e.g., both sequentially and in reverse order).

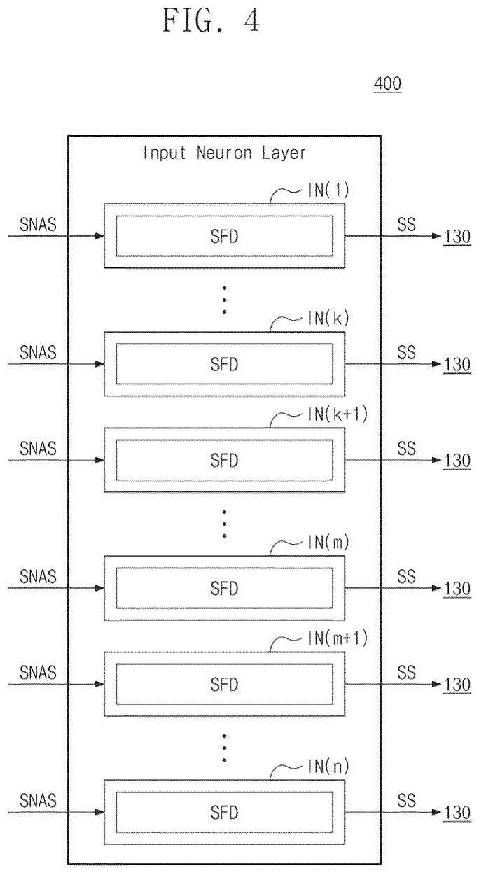

FIG. 4 is a block diagram illustrating an input neuron layer 400, according to an embodiment of the present disclosure. Referring to FIG. 4, the input neuron layer 400 may include the first to n-th input neurons IN(1) to IN(n), each of which includes a spike firing device SFD.

Each of the first to n-th input neurons IN(1) to IN(n) may receive the spike number allocating signal SNAS from the first spike number allocator (340a in FIG. 3) or the second spike number allocator (340b in FIG. 3). Among the first to n-th input neurons IN(1) to IN(n), the input neuron that receives the spike number allocating signal SNAS may increase the number of spikes firing in the corresponding input neuron. In detail, the first to m-th input neurons IN(1) to IN(m) may receive the spike number allocating signal SNAS from the first spike number allocator 340a, and the (m+1)-th to n-th input neurons IN(m+1) to IN(n) may receive the spike number allocating signal SNAS from the second spike number allocator 340b.

When the number of spikes firing in each of the first to n-th input neurons IN(1) to IN(n) corresponding to the voltage features and the time features extracted from the received time-series data TD is determined, the spike firing device SFD may fire a spike signal SS to the synaptic weight layer (130 of FIG. 1) according to a rate proportional to the number of spikes allocated to fire at each of the first to n-th input neurons IN(1) to IN(n).

In detail, the spike firing device SFD included in each of the first to n-th input neurons IN(1) to IN(n) may fire the spike signal SS depending on a rate proportional to the number of spikes allocated to the corresponding input neuron IN by a rate-coding technique.

In this case, a spike distribution of the spike signal SS firing in each of the first to n-th input neurons IN(1) to IN(n) may have, for example, a Poisson distribution or a similar random distribution.

According to an embodiment according to the present disclosure, voltage features and time features included in different time-series data TD) may correspond to different input neurons (e.g., the voltage features correspond to the first to m-th input neurons IN(1) to IN(m), and the time features correspond to the (m+1)-th to n-th input neurons IN(m+1) to IN(n)), and the degree of inclusion (e.g., importance or magnitude) of the change component of the signal (e.g., amplitude or frequency) related to the corresponding feature may be allocated in proportion to the number of spikes firing in each of the first to n-th input neurons IN(1) to IN(n). Therefore, the embodiment according to the present disclosure may provide a spike encoding capable of unsupervised learning having a STDP (Spike-Timing-Dependent Plasticity) method, which may train features between subjects that need to be distinguished by the location of the input neuron IN and the number of spikes (i.e., spike frequency).

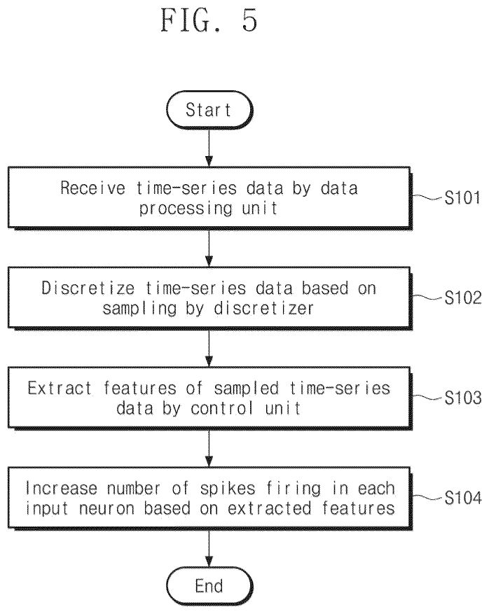

FIG. 5 is a flowchart illustrating a method of operating the data processing unit 200, according to an embodiment of the present disclosure. Referring to FIG. 5, in operation S101, the data processing unit 200 may receive the time-series data TD from the outside (not illustrated).

In operation S102, the discretizer 210 may generate the sampled time-series data STD by discretizing the received time-series data TD based on sampling.

In operation S103, the control unit 220 may receive the sampled time-series data STD and may extract voltage features and time features of the sampled time-series data.

In operation S104, the control unit 220 may output the spike number allocating signal SNAS that increases the number of spikes firing in the input neuron corresponding to each extracted feature based on the extracted voltage features and the extracted time features.

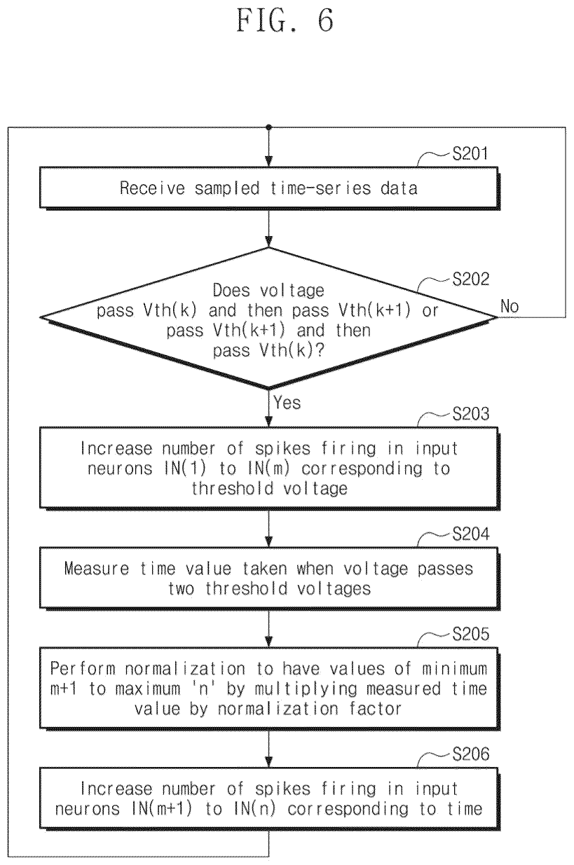

FIG. 6 is a flowchart illustrating a method of operating the control unit 300, according to an embodiment of the present disclosure. Referring to FIG. 6, in operation S201, the control unit 300 may receive the sampled time-series data STD from the discretizer 210.

In operation S202, the comparator 310 may detect that the voltage of the sampled time-series data STD passes sequentially or in reverse order the two nearest threshold voltages, for example, the k-th threshold voltage Vth(k) and the (k+1)-th threshold voltage Vth(k+1) over time. When the voltage of the sampled time-series data STD passes the k-th threshold voltage Vth(k) and the (k+1)-th threshold voltage Vth(k+1) sequentially or in reverse order, the control unit 300 may proceed to operation S203. When the voltage of the sampled time-series data STD does not pass the k-th threshold voltage Vth(k) and the (k+1)-th threshold voltage Vth(k+1) sequentially or in reverse order, the control unit 300 may return to operation S201, and then may repeat the above-described process over time.

In operation S203, the first spike number allocator 340a may output the spike number allocating signal SNAS that increases the number of spikes firing in the k-th input neuron IN(k) or the (k+1)-th input neuron IN(k+1) corresponding to the k-th threshold voltage Vth(k) or the (k+1)-th threshold voltage Vth(k+1).

In FIG. 6, operation S203 is illustrated as being performed before operation S204, but this is only an example sequence and the present disclosure is not limited thereto. operation S203 may proceed after operation S202, and may proceed simultaneously with operations S204, S205, and S206, or before or after operations S204, S205, and S206.

In operation S204, the counter 320 may measure the time value CNT taken when the voltage of the sampled time-series data STD passes the two adjacent threshold voltages, that is, the k-th threshold voltage Vth(k) and the (k+1)-th threshold voltage Vth(k+1).

In operation S205, the normalization device 330 may perform normalization such that normalized time value CNT_norm calculated by multiplying the time value CNT by a normalization factor “p” has an integer value of m+1 or more and “n” or less.

In operation S206, the second spike number allocator 340b may output the spike number allocating signal SNAS that increases the number of spikes firing in the j-th input neuron IN(j) (where, “j” is CNT_norm) the corresponding to the normalized time value CNT_norm.

After operation S206 proceeds, the control unit 300 may return to operation S201 and may repeat the above-described processes. The flowchart illustrated in FIG. 6 may be an infinite loop process that is continuously repeated, and the infinite loop may be initiated while detecting voltage changes over time from the point in time of the sampled time-series data STD received in operations S201 and S202. In the flowchart of the infinite loop process of the operating method of the control unit 300 illustrated in FIG. 6, the voltage change in the sampled time-series data STD are detected in chronological order from the point of time of the received sampled time-series data STD, and the infinite loop may be repeated. When the process for all of the sampled time-series data STD is completed, the process in FIG. 6 may be terminated.

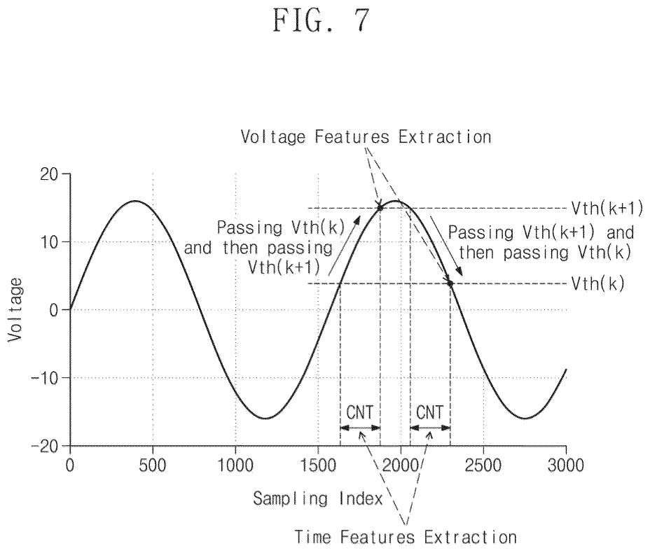

FIG. 7 is a graph illustrating an extraction of voltage features and time features of time-series data, according to an embodiment of the present disclosure. FIG. 7 illustrates a graph for convenience of understanding of the configuration for extracting voltage features and time features of the sampled time-series data STD by the control unit 300. A horizontal axis of the graph in FIG. 7 may indicate a sampling index of the sampled time-series data STD obtained by sampling the time-series data TD, and a vertical axis may indicate a voltage of the sampled time-series data STD. Through FIGS. 3, 6, and 7, a configuration for extracting voltage features and time features of the sampled time-series data STD according to an embodiment of the present disclosure will be described.

Referring to FIG. 7, the comparator 310 of the control unit 300 may extract voltage features and time features of the sampled time-series data STD by detecting that the voltage waveform of the sampled time-series data STD rises and passes the k-th threshold voltage Vth(k) and then passes the (k+1)-th threshold voltage Vth(k+1), and detecting that the voltage waveform of the sampled time-series data STD falls and passes the (k+1)-th threshold voltage Vth(k+1) and then passes the k-th threshold voltage Vth(k) (S202 in FIG. 6).

The counter 320 may measure, in operation S204 in FIG. 6, the time value CNT taken when the voltage of the sampled time-series data STD passes sequentially or in reverse order two threshold voltages, that is, the k-th threshold voltage Vth(k) and the (k+1)-th threshold voltage Vth(k+1), according to the above detection in operation S202 of the comparator 310. In this case, the time value CNT may be the same when the time-series data TD is a signal with a uniform period.

The description of the operations after the detection S202 of the comparator 310 and the measurement S204 of the time value CNT of the counter 320 in the control unit 300 is the same as described above in FIGS. 3 and 6 and will therefore be omitted to avoid redundancy.

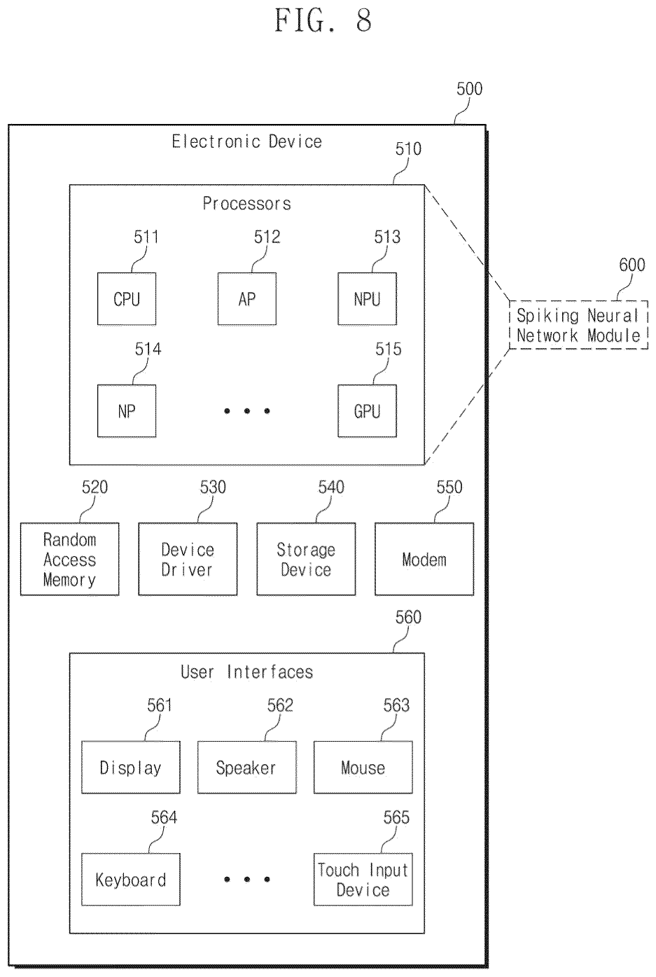

FIG. 8 is a block diagram illustrating an electronic device 500, according to an embodiment of the present disclosure. Referring to FIG. 8, the electronic device 500 may be configured to execute a spiking neural network (SNN) module 600. The electronic device 500 may perform some of the functions or the processes of the spiking neural network 100 described with reference to FIG. 1. The electronic device 500 may include processors 510, a random access memory 520, a device driver 530, a storage device 540, a MODEM 550, and user interfaces 560.

The processors 510 may include, for example, at least one general-purpose processor such as a central processing device (CPU) 511 or an application processor (AP) 512. The processors 510 may also include at least one special purpose processor, such as a neural processing unit (NPU) 513, a neuromorphic processor (NP) 514, a graphics processing unit (GPU) 515, etc. The processors 510 may include two or more homogeneous processors.

At least one of the processors 510 may execute the spiking neural network (SNN) module 600. The spiking neural network (SNN) module 600 may be configured to extract voltage features and time features from the received time-series data TD and to generate encoded spike signals based on the extracted features.

For example, the spiking neural network (SNN) module 600 may be implemented in the form of instructions (or codes) that are executed by at least one of the processors 510. In this case, the at least one processor may load the instructions (or codes) of the spiking neural network SNN module 600 onto the random access memory 520.

As another example, the at least one (or at least the other) of the processors 510 may be manufactured to implement the spiking neural network (SNN) module 600. For example, at least one processor may be a dedicated processor implemented in hardware based on the spiking neural network (SNN) module 600.

As another example, at least one (or at least the other) of the processors 510 may be manufactured to implement various machine learning modules or various deep learning modules. The at least one processor may implement the spiking neural network (SNN) module 600 by receiving information (e.g., instructions or codes) corresponding to the spiking neural network (SNN) module 600.

The random access memory 520 may be used as a working memory of the processors 510 and may be used as a main memory or a system memory of the electronic device 500. The random access memory 520 may include a volatile memory such as a dynamic random access memory or a static random access memory or a nonvolatile memory such as a phase-change random access memory, a ferroelectric random access memory, a magnetic random access memory, or a resistive random access memory.

The device driver 530 may control the following peripheral devices depending on a request of the processors 510: the storage device 540, the MODEM 550, and the user interfaces 560. The storage device 540 may include a stationary storage device such as a hard disk drive or a solid state drive, or a removable storage device such as an external hard disk drive, an external solid state drive, or a removable memory card.

The MODEM 550 may provide remote communication with an external device. The MODEM 550 may perform wired or wireless communication with the external device. The MODEM 550 may communicate with the external device based on at least one of various communication schemes such as Ethernet, wireless-fidelity (Wi-Fi), long term evolution (LTE), and 5th generation (5G) mobile communication.

The user interfaces 560 may receive information from a user and may provide information to the user. The user interfaces 560 may include at least one user output interface such as a display 561 or a speaker 562, and at least one user input interface such as a mice 563, a keyboard 564, or a touch input device 565.

The instructions (or codes) of the spiking neural network (SNN) module 600 may be received through the MODEM 550 and may be stored in the storage device 540. The instructions (or codes) of the spiking neural network (SNN) module 600 may be stored in a removable storage device, and the removable storage device may be connected with the electronic device 500. The instructions (or codes) of the spiking neural network (SNN) module 600 may be loaded onto the random access memory 520 from the storage device 540 and may be executed on the random access memory 520.

By way of example, the spiking neural network (SNN) module 600 may include at least one of the data processing unit 110, the input neuron layer 120, the synaptic weight layer 130, and the output neuron layer 140 described with reference to FIG. 1. The data processing unit 110, the input neuron layer 120, the synaptic weight layer 130, and the output neuron layer 140 may be implemented or executed in different electronic devices. Two or more modules of the data processing unit 110, the input neuron layer 120, the synaptic weight layer 130, and the output neuron layer 140 may be implemented or executed in one electronic device.

According to an embodiment of the present disclosure, the data processing device extracts voltage features and time features of time-series data input to a spiking neural network and converts the extracted features into spike signals.

Accordingly, the data processing device of the spiking neural network is provided that is capable of unsupervised learning using the STDP (Spike-Timing-Dependent Plasticity) method with respect to features of time-series data in which encoded spike signals change.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

What is claimed is:

1. A data processing device of a spiking neural network comprising:
a discretizer configured to receive time-series data, to discretize the time-series data based on sampling, and to output sampled time-series data; and
a control unit configured to receive the sampled time-series data, to extract a voltage feature and a time feature from the sampled time-series data, and to increase the number of spikes firing in an input neuron corresponding to the voltage feature and the time feature from among a plurality of input neurons including first to n-th input neurons, and
wherein the “n” is an arbitrary positive integer.

2. The data processing device of the spiking neural network of claim 1, wherein the control unit includes:
a voltage comparator configured to detect that a voltage of the sampled time-series data passes sequentially or in reverse order between a k-th threshold voltage and a (k+1)-th threshold voltage adjacent to each other from among a plurality of threshold voltages including first to m-th threshold voltages, magnitudes of which increase sequentially, and wherein the “m” is an arbitrary positive integer less than the “n”, and the “k” is an arbitrary positive integer less than the “m”; and
a first spike number allocator configured to increase the number of spikes firing in the input neuron corresponding to the (k+1)-th threshold voltage among the plurality of input neurons when the voltage of the sampled time-series data sequentially passes between the k-th threshold voltage and the (k+1)-th threshold voltage, and to increase the number of spikes firing in the input neuron corresponding to the k-th threshold voltage among the plurality of input neurons when the voltage of the sampled time-series data passes in reverse order between the k-th threshold voltage and the (k+1)-th threshold voltage.

3. The data processing device of the spiking neural network of claim 2, further comprising:
a counter configured to measure a time value taken when the voltage of the sampled time-series data passes sequentially or in reverse order between the k-th threshold voltage and the (k+1)-th threshold voltage, as an arbitrary integer;
a normalization device configured to normalize the time value within a specific range to calculate the normalized time value; and
a second spike number allocator configured to increase the number of spikes firing in the input neuron corresponding to the normalized time value.

4. The data processing device of the spiking neural network of claim 3, wherein the normalization device is configured to receive the time value from the counter, to multiply the received time value by a normalization factor to normalize the time value within the specific range, and to calculate the normalized time value, and
wherein the specific range is a range of m+1 or more and “n” or less.

5. The data processing device of the spiking neural network of claim 4, wherein the number of spikes firing in the input neuron, which is increased by the first and second spike number allocators is “1” or an arbitrary integer.

6. The data processing device of the spiking neural network of claim 4, wherein the first to m-th threshold voltages correspond to first to m-th input neurons among the first to n-th input neurons, respectively, and
wherein the normalized time value having a value within the range of the m+1 or more and the “n” or less corresponds to the (m+1)-th to n-th input neurons among the first to n-th input neurons, each of which has an index matching the normalized time value.

7. The data processing device of the spiking neural network of claim 4, wherein the number of spikes fired by the input neuron is proportional to the number of spikes increased by the first and second spike number allocators, and
wherein a distribution of the spikes has a Poisson distribution.

8. A method of operating a data processing device of a spiking neural network, the method comprising:
receiving time-series data, by a discretizer, and discretizing the time-series data based on sampling to output sampled time-series data; and
receiving, by a control unit, the sampled time-series data, extracting a voltage feature and a time feature from the sampled time-series data, and increasing the number of spikes firing in an input neuron corresponding to the voltage feature and the time feature from among a plurality of input neurons including first to n-th input neurons, and
wherein the “n” is an arbitrary positive integer.

9. The method of claim 8, wherein the increasing of the number of spikes includes:
detecting, by a voltage comparator, that a voltage of the sampled time-series data passes sequentially or in reverse order between a k-th threshold voltage and a (k+1)-th threshold voltage adjacent to each other from among a plurality of threshold voltages including first to m-th threshold voltages, magnitudes of which increase sequentially; and
increasing, by a first spike number allocator, the number of spikes firing in the input neuron corresponding to the (k+1)-th threshold voltage among the plurality of input neurons when the voltage of the sampled time-series data sequentially passes between the k-th threshold voltage and the (k+1)-th threshold voltage, and increasing the number of spikes firing in the input neuron corresponding to the k-th threshold voltage among the plurality of input neurons when the voltage of the sampled time-series data passes in reverse order between the k-th threshold voltage and the (k+1)-th threshold voltage, and
wherein the “m” is an arbitrary positive integer less than the “n”, and the “k” is an arbitrary positive integer less than the “m”.

10. The method of claim 9, wherein the increasing of the number of spikes includes:
measuring, by a counter, a time value taken when the voltage of the sampled time-series data passes sequentially or in reverse order between the k-th threshold voltage and the (k+1)-th threshold voltage, as an arbitrary integer;
normalizing, by a normalization device, the time value within a specific range to calculate the normalized time value; and
increasing, by a second spike number allocator, the number of spikes firing in the input neuron corresponding to the normalized time value.

11. The method of claim 10, wherein the calculating of the normalized time value further includes:
receiving, by the normalization device, the time value, and multiplying the received time value by a normalization factor to normalize the time value within the specific range.

12. The method of claim 11, wherein the number of spikes firing in the input neuron, which is increased by the first and second spike number allocators is “1” or an arbitrary integer.

13. The method of claim 11, wherein the first to m-th threshold voltages correspond to first to m-th input neurons among the first to n-th input neurons, respectively, and
wherein the normalized time value having a value within a range of m+1 or more and “n” or less corresponds to (m+1)-th to n-th input neurons among the first to n-th input neurons, each of which has an index matching the normalized time value.

14. The method of claim 11, further comprising:
firing, by the input neuron, spikes, the number of which is proportional to the number of spikes increased by the first and second spike number allocators, and
wherein the firing spikes have a Poisson distribution.
